(19) United States
(12) Patent Application Publication
(10) Pub. No.: US 2018/0321867 A1
(43) Pub. Date: Nov. 8, 2018

(54) STORAGE MANAGEMENT SYSTEM AND METHOD

(71) Applicant: EMC IP Holding Company, LLC, Hopkinton, MA (US)

(72) Inventors: Yourong Wang, Shanghai (CN); Yingyan Zheng, Shanghai (CN); Yujie Xie, Shanghai (CN); Junyi Zhang, Shanghai (CN); Zhanqing Wu, Shanghai (CN); Zhidong Mao, Shanghai (CN)

(21) Appl. No.: 16/038,530

(22) Filed: Jul. 18, 2018

(30) Foreign Application Priority Data
Mar. 31, 2017 (CN) 201710643708.2

(51) Int. Cl. G06F 3/06

(52) U.S. Cl. CPC G06F 3/0638; G06F 3/0649; G06F 3/0629; G06F 3/0689; G06F 3/061; G06F 3/067; G06F 3/0604

(57) ABSTRACT

A method, computer program product, and computing system for receiving a plurality of requests to store at least one data object in a storage array. A ranking of a plurality of data object types in order of significance may be received. One or more data objects of a plurality of data objects may be removed from the storage array based upon, at least in part, the ranking of the one or more data object types of a plurality of data object types associated with the one or more data objects of the plurality of data objects. The at least one data object may be stored in the storage array.

### RELATED CASES

The subject application claims the priority of China Patent Application No. 201710643708.2, filed on 31 Jul. 2017, the contents of which are herein incorporated by reference in its entirety.

### BACKGROUND

Storing and safeguarding electronic content may be beneficial in modern business and elsewhere. Accordingly, large data storage systems may be utilized to protect such electronic content, wherein such large data storage systems may be configured as data storage arrays to provide a high level of data availability. Such large data storage systems may store various data objects of various data object types.

### SUMMARY OF DISCLOSURE

In one example implementation, a computer-implemented method is executed on a computing device and may include but is not limited to receiving, at the computing device, a plurality of requests to store at least one data object in a storage array. A ranking of a plurality of data object types in order of significance may be received. One or more data objects of a plurality of data objects may be removed from the storage array based upon, at least in part, the ranking of the one or more data object types of a plurality of data object types associated with the one or more data objects of the plurality of data objects. The at least one data object may be stored in the storage array.

One or more of the following example features may be included. Receiving the plurality of requests to store the at least one data object may include determining a maximum storage usage for the storage array. Removing the one or more data objects may include removing one or more core dump data objects of one or more data object types generated within a predefined period of time. Removing the one or more data objects may include determining a current storage usage for at least one data object type of the plurality of data object types in the storage array, determining a maximum storage usage for the at least one data object type of the plurality of data objects types, and removing the one or data objects until the current storage usage for the one or more data object types associated with the one or more data objects is below the maximum storage usage for the one or more data object types associated with the one or more data objects. Removing the one or more data objects may include removing one or more data objects of a first data object type based upon, at least in part, the ranking of the first data object type and, when each of the one or more data objects of the first data object type are removed, removing one or more data objects of a second data object type based upon, at least in part, the ranking of the second data object type. Removing the one or more data objects may include removing a data object of a first data object type based upon, at least in part, the ranking of the first data object type and removing a data object of a second data object type based upon, at least in part, the ranking of the second data object type. Removing the one or more data objects may include removing one or more oldest data objects of the one or more data objects of the one or more data object types.

In another example implementation, a computer program product resides on a computer readable medium that has a plurality of instructions stored on it. When executed by a processor, the instructions cause the processor to perform operations that may include but are not limited to receiving a plurality of requests to store at least one data object in a storage array. A ranking of a plurality of data object types in order of significance may be received. One or more data objects of a plurality of data objects may be removed from the storage array based upon, at least in part, the ranking of the one or more data object types of a plurality of data object types associated with the one or more data objects of the plurality of data objects. The at least one data object may be stored in the storage array.

One or more of the following example features may be included. Receiving the plurality of requests to store the at least one data object may include determining a maximum storage usage for the storage array. Removing the one or more data objects may include removing one or more core dump data objects of one or more data object types generated within a predefined period of time. Removing the one or more data objects may include determining a current storage usage for at least one data object type of the plurality of data object types in the storage array, determining a maximum storage usage for the at least one data object type of the plurality of data objects types, and removing the one or data objects until the current storage usage for the one or more data object types associated with the one or more data objects is below the maximum storage usage for the one or more data object types associated with the one or more data objects. Removing the one or more data objects may include removing one or more data objects of a first data object type based upon, at least in part, the ranking of the first data object type and, when each of the one or more data objects of the first data object type are removed, removing one or more data objects of a second data object type based upon, at least in part, the ranking of the second data object type. Removing the one or more data objects may include removing a data object of a first data object type based upon, at least in part, the ranking of the first data object type and removing a data object of a second data object type based upon, at least in part, the ranking of the second data object type. Removing the one or more data objects may include removing one or more oldest data objects of the one or more data objects of the one or more data object types.

In another example implementation, a computing system includes at least one processor and at least one memory architecture coupled with the at least one processor, wherein the computing system is configured to perform operations that may include but are not limited to receiving a plurality of requests to store at least one data object in a storage array. A ranking of a plurality of data object types in order of significance may be received. One or more data objects of a plurality of data objects may be removed from the storage array based upon, at least in part, the ranking of the one or more data object types of a plurality of data object types associated with the one or more data objects of the plurality of data objects. The at least one data object may be stored in the storage array.

One or more of the following example features may be included. Receiving the plurality of requests to store the at least one data object may include determining a maximum storage usage for the storage array. Removing the one or more data objects may include removing one or more core dump data objects of one or more data object types generated within a predefined period of time. Removing the one or more data objects may include determining a current storage usage for at least one data object type of the plurality of data object types in the storage array, determining a maximum storage usage for the at least one data object type of the plurality of data objects types, and removing the one or data objects until the current storage usage for the one or more data object types associated with the one or more data objects is below the maximum storage usage for the one or more data object types associated with the one or more data objects. Removing the one or more data objects may include removing one or more data objects of a first data object type based upon, at least in part, the ranking of the first data object type and, when each of the one or more data objects of the first data object type are removed, removing one or more data objects of a second data object type based upon, at least in part, the ranking of the second data object type. Removing the one or more data objects may include removing a data object of a first data object type based upon, at least in part, the ranking of the first data object type and removing a data object of a second data object type based upon, at least in part, the ranking of the second data object type. Removing the one or more data objects may include removing one or more oldest data objects of the one or more data objects of the one or more data object types.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a storage management process coupled to a distributed computing network according to one or more example implementations of the disclosure;

FIG. 2 is an example diagrammatic view of the storage system of FIG. 1 according to one or more example implementations of the disclosure;

FIG. 3 is another example diagrammatic view of the storage system of FIG. 1 according to one or more example implementations of the disclosure; and

FIG. 4 is an example flowchart of the storage management process of FIG. 1 according to one or more example implementations of the disclosure.

Like reference symbols in the various drawings indicate like elements.

### DETAILED DESCRIPTION

### System Overview:

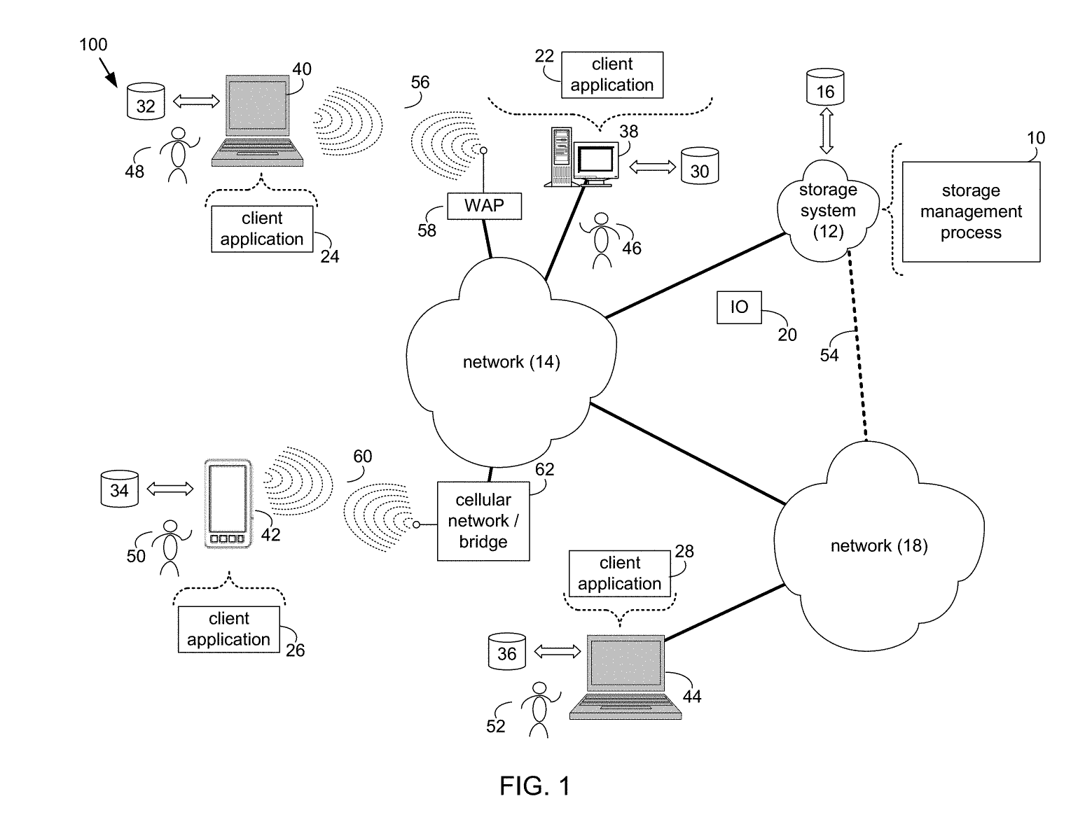

Referring to the example implementation of FIG. 1, there is shown storage management process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of storage management process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of storage management process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (i.e. a request that content be written to storage system 12) and data read requests (i.e. a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a storage management process, such as storage management process 10 of FIG. 1, may include but is not limited to, receiving, at the computing device, a plurality of requests to store at least one data object in a storage array. A ranking of a plurality of data object types in order of significance may be received. One or more data objects of a plurality of data objects may be removed from the storage array based upon, at least in part, the ranking of the one or more data object types of a plurality of data object types associated with the one or more data objects of the plurality of data objects. The at least one data object may be stored in the storage array.

For example purposes, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

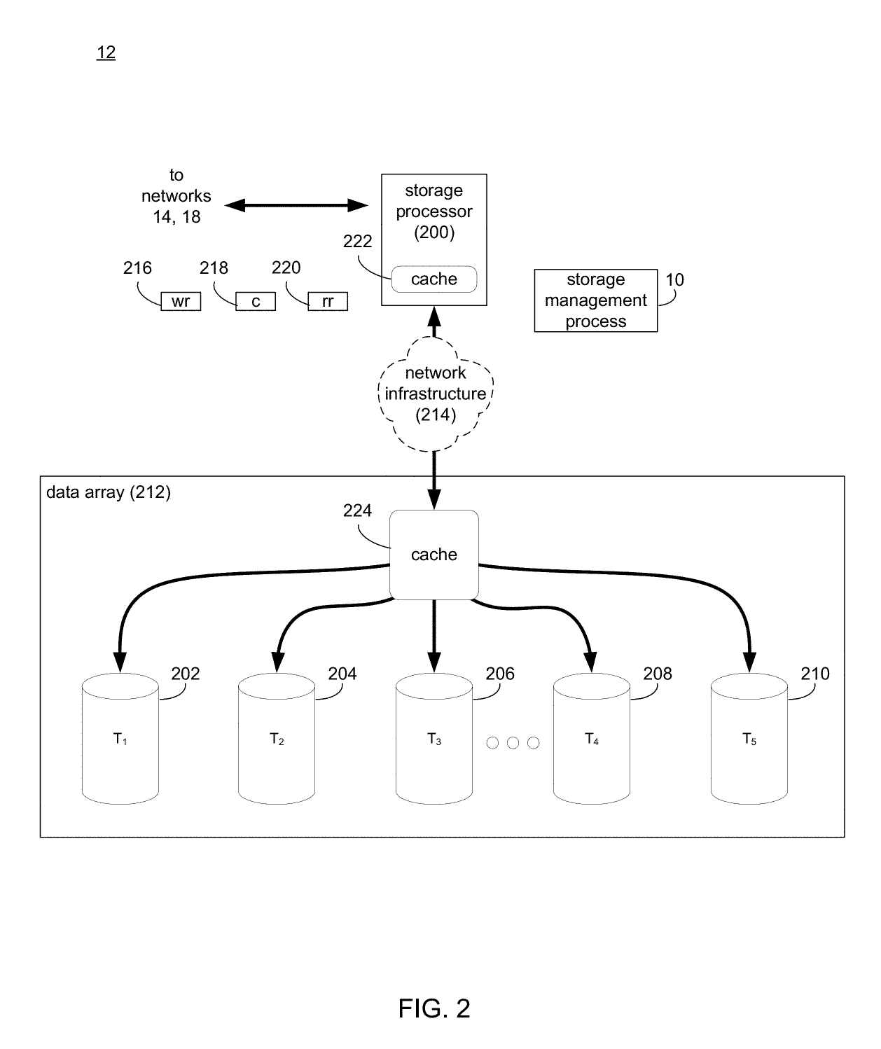

Referring also to the example implementation of FIG. 2, storage system 12 may include storage processor 200 and a plurality of storage targets T 1-n (e.g., storage targets 202, 204, 206, 208). Storage targets 202, 204, 206, 208 may be configured to provide various levels of performance and/or high availability. For example, one or more of storage targets 202, 204, 206, 208 may be configured as a RAID 0 array, in which data is striped across storage targets. By striping data across a plurality of storage targets, improved performance may be realized. However, RAID 0 arrays do not provide a level of high availability. Accordingly, one or more of storage targets 202, 204, 206, 208 may be configured as a RAID 1 array, in which data is mirrored between storage targets. By mirroring data between storage targets, a level of high availability is achieved as multiple copies of the data are stored within storage system 12.

While storage targets 202, 204, 206, 208 are discussed above as being configured in a RAID 0 or RAID 1 array, this is for example purposes only and is not intended to be a limitation of this disclosure, as other configurations are possible. For example, storage targets 202, 204, 206, 208 may be configured as a RAID 3, RAID 4, RAID 5 or RAID 6 array.

While in this particular example, storage system 12 is shown to include four storage targets (e.g., storage targets 202, 204, 206, 208), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 202, 204, 206, 208. An example of such a coded target may include but is not limited to a hard disk drive that is used to store parity data within a RAID array.

While in this particular example, storage system 12 is shown to include one coded target (e.g., coded target 210), this is for example purposes only and is not intended to be a limitation of this disclosure. Specifically, the actual number of coded targets may be increased or decreased depending upon e.g., the level of redundancy/performance/capacity required.

Examples of storage targets 202, 204, 206, 208 and coded target 210 may include one or more electro-mechanical hard disk drives and/or solid-state/flash devices, wherein a combination of storage targets 202, 204, 206, 208 and coded target 210 and processing/control systems (not shown) may form data array 212.

The manner in which storage system 12 is implemented may vary depending upon e.g., the level of redundancy/performance/capacity required. For example, storage system 12 may be a RAID device in which storage processor 100 is a RAID controller card and storage targets 202, 204, 206, 208 and/or coded target 110 are individual “hot-swappable” hard disk drives. Another example of such a RAID device may include but is not limited to an NAS device. Alternatively, storage system 12 may be configured as a SAN, in which storage processor 200 may be e.g., a server computer and each of storage targets 202, 204, 206, 208 and/or coded target 210 may be a RAID device and/or computer-based hard disk drives. Further still, one or more of storage targets 202, 204, 206, 208 and/or coded target 210 may be a SAN.

In the event that storage system 12 is configured as a SAN, the various components of storage system 12 (e.g., storage processor 100, storage targets 202, 204, 206, 208, and coded target 210) may be coupled using network infrastructure 214, examples of which may include but are not limited to an Ethernet (e.g., Layer 2 or Layer 3) network, a fiber channel network, an InfiniBand network, or any other circuit switched/packet switched network.

Storage system 12 may execute all or a portion of storage management process 10. The instruction sets and subroutines of storage management process 10, which may be stored on a storage device (e.g., storage device 16) coupled to storage processor 200, may be executed by one or more processors (not shown) and one or more memory architectures (not shown) included within storage processor 200. Storage device 16 may include but is not limited to: a hard disk drive; a tape drive; an optical drive; a RAID device; a random access memory (RAM); a read-only memory (ROM); and all forms of flash memory storage devices. As discussed above, some portions of the instruction sets and subroutines of storage management process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 200 is configured as an application server, these IO requests may be internally generated within storage processor 200. Examples of IO request 20 may include but are not limited to data write request 216 (i.e. a request that content 218 be written to storage system 12) and data read request 220 (i.e. a request that content 218 be read from storage system 12).

During operation of storage processor 200, content 218 to be written to storage system 12 may be processed by storage processor 200. Additionally/alternatively and when storage processor 200 is configured as an application server, content 118 to be written to storage system 12 may be internally generated by storage processor 200.

Storage processor 200 may include frontend cache memory system 222. Examples of frontend cache memory system 222 may include but are not limited to a volatile, solid-state, cache memory system (e.g., a dynamic RAM cache memory system) and/or a non-volatile, solid-state, cache memory system (e.g., a flash-based, cache memory system).

Storage processor 200 may initially store content 118 within frontend cache memory system 222. Depending upon the manner in which frontend cache memory system 222 is configured, storage processor 200 may immediately write content 218 to data array 212 (if frontend cache memory system 222 is configured as a write-through cache) or may subsequently write content 218 to data array 212 (if frontend cache memory system 222 is configured as a write-back cache).

Data array 212 may include backend cache memory system 224. Examples of backend cache memory system 224 may include but are not limited to a volatile, solid-state, cache memory system (e.g., a dynamic RAM cache memory system) and/or a non-volatile, solid-state, cache memory system (e.g., a flash-based, cache memory system). During operation of data array 212, content 218 to be written to data array 212 may be received from storage processor 200. Data array 212 may initially store content 218 within backend cache memory system 224 prior to being stored on e.g., one or more of storage targets 202, 204, 206, 208, and coded target 210.

As discussed above, the instruction sets and subroutines of storage management process 10, which may be stored on storage device 16 included within storage system 12, may be executed by one or more processors (not shown) and one or more memory architectures (not shown) included within storage system 12. Accordingly, in addition to being executed on storage processor 200, some or all of the instruction sets and subroutines of storage management process 10 may be executed by one or more processors (not shown) and one or more memory architectures (not shown) included within data array 212.

Further and as discussed above, during the operation of data array 212, content (e.g., content 218) to be written to data array 212 may be received from storage processor 200 and initially stored within backend cache memory system 224 prior to being stored on e.g., one or more of storage targets 202, 204, 206, 208, 210. Accordingly, during use of data array 212, backend cache memory system 224 may be populated (e.g., warmed) and, therefore, subsequent read requests may be satisfied by backend cache memory system 224 (e.g., if the content requested in the read request is present within backend cache memory system 124), thus avoiding the need to obtain the content from storage targets 202, 204, 206, 208, 210 (which would typically be slower).

### The Storage Management Process:

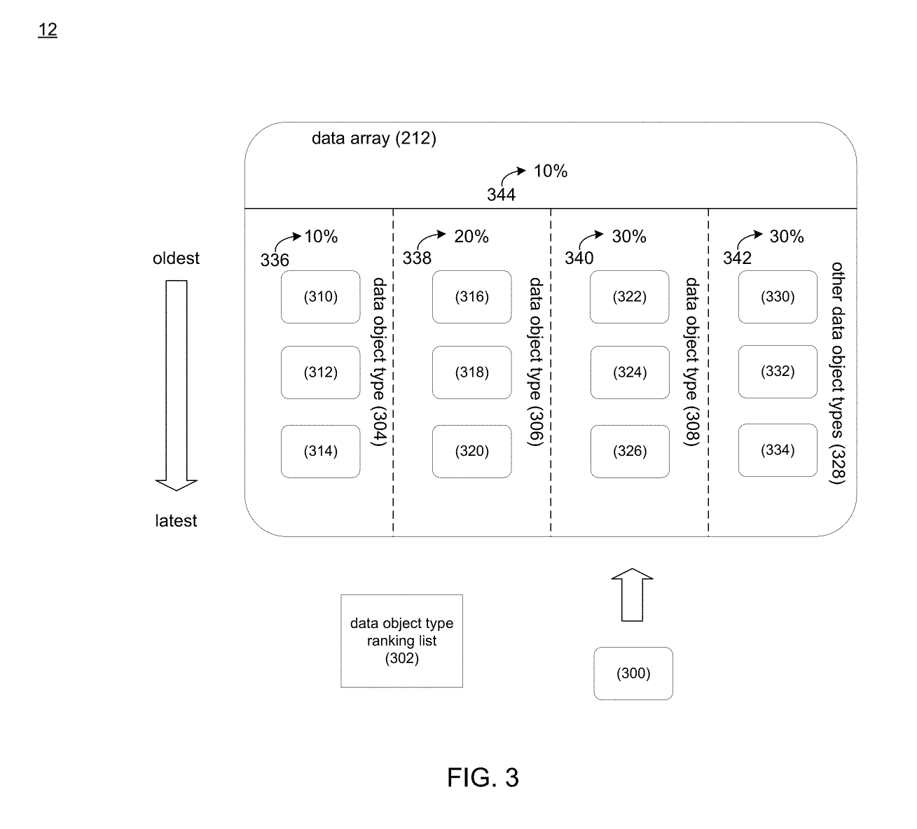

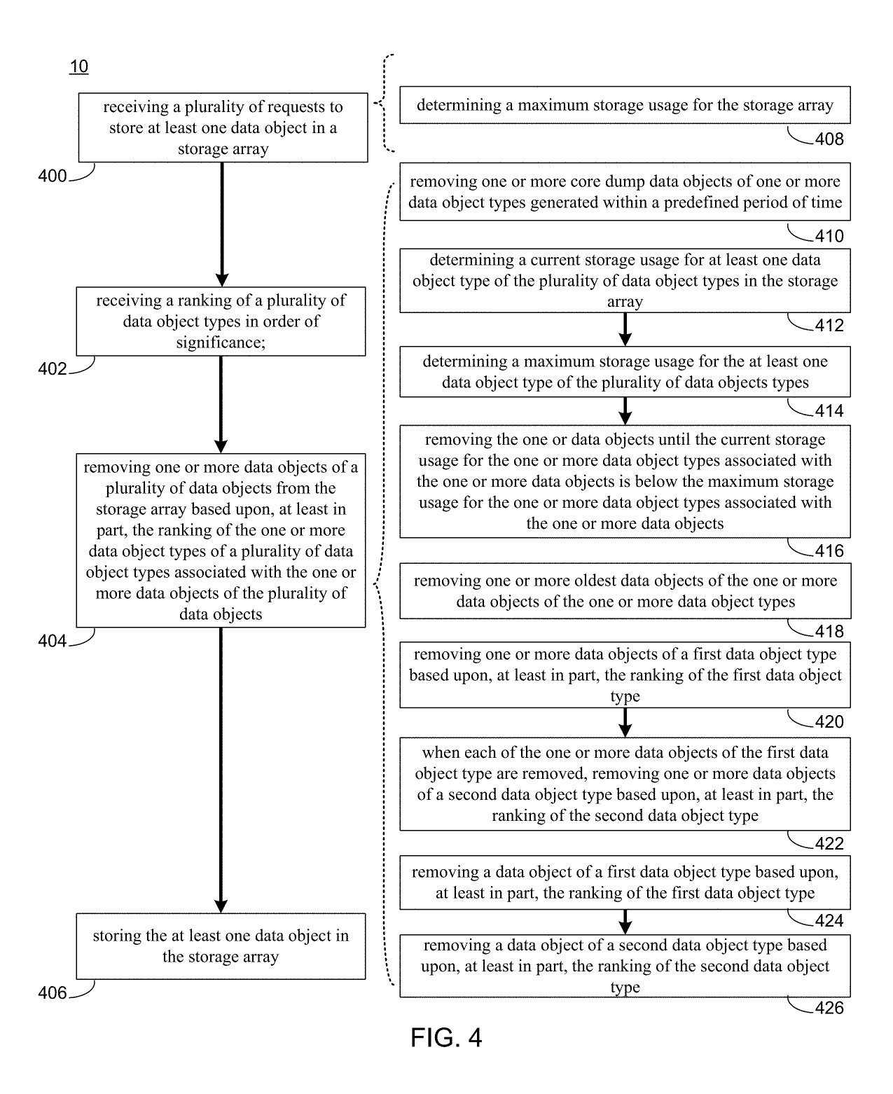

Referring also to the example implementations of FIGS. 3-4, storage management process 10 may receive 400 a plurality of requests to store at least one data object in a storage array. Storage management process 10 may receive 402 a ranking of a plurality of data object types in order of significance. Storage management process 10 may remove 404 one or more data objects of a plurality of data objects from the storage array based upon, at least in part, the ranking of the one or more data object types of a plurality of data object types associated with the one or more data objects of the plurality of data objects. Storage management process 10 may store 406 the at least one data object in the storage array.

For example, a request (e.g., a plurality of IO requests) may be received to store at least one data object (e.g., data object 300) in a storage array (e.g., data array 212). A data object may generally include, but is not limited to, content (e.g., content 118) of a write request (e.g., write request 216), one or more files, etc.

In some implementations, receiving 400 the plurality of requests to store the at least one data object may include determining 408 a maximum storage usage for the storage array. For example, before storing the at least one data object (e.g., data object 300) to the data array (e.g., data array 212), storage management process 10 may determine the maximum storage usage for the storage array. A storage array (e.g., storage array 212) and/or storage targets within a storage array (e.g., storage targets 202, 204, 206, 208, 210) may include a maximum storage usage or maximum disk usage (MDU). In some implementations, the maximum storage usage may represent the maximum amount of data allowed in a storage array and/or in a storage target within a storage array. In some implementations, the maximum storage usage may be represented as a percentage of a total storage capacity of the storage array and/or the storage target within a storage array. In some implementations, the maximum storage usage of the storage array may be user-defined, defined by storage management process 10, and/or may be a pre-defined value associated with data array 212.

For example, suppose storage array 212 has a maximum storage usage of 90%. In some implementations, storage management process 10 may determine whether the current storage usage (e.g., a currently occupied or used amount of the total capacity) of the storage array plus the storage capacity required to store the at least one data object exceeds the maximum storage usage (e.g., current storage usage plus storage capacity required to store the at least one data object >90% of total capacity of storage array). If storage management process 10 determines that the storage of data object 300 will not exceed the maximum storage usage, storage management process 10 may store data object 300 in data array 212. As will be discussed in greater detail below, if storage management process 10 determines that the current storage usage plus the storage capacity required to store the at least one data object exceeds the maximum storage usage, storage management process 10 may remove one or more data objects stored in data array 212.

In some implementations, storage management process 10 may receive 402 a ranking of a plurality of data object types in order of significance. In some implementations, a data object may be associated with and/or may be of a data object type. Examples of data object types may include, but are not limited to, a user data object type, a diagnostic data object type, an application-specific data object type, a file format, and/or combinations thereof. In some implementations, user data object types may include, but are not limited to, data object types created and/or modified by a user (e.g., via client applications 22, 24, 26, 28). User data object types may generally include but are not limited to audio data object types (e.g., audio file formats, standards, and extensions such as MP3 data objects (.mp3), WMA data objects (.wav), etc.); media or multi-media data object types (e.g., media files such as RealMedia Variable Bitrate (.rmvb) of the RealMedia® multimedia digital container format (RealMedia is a registered trademark of RealNetworks, Inc. in the United States, other countries or both), etc.); compressed data object types (e.g., compressed file types such as package data objects (.pkg), RAR data objects (.rar), etc.); disc data object types (e.g., disc or media files such as binary disc images (.bin), etc.); database data object types (e.g., data files related to a database such as comma separated value files (.csv), data files (.dat or .data), log files (.log), XML files (.xml), etc.); executable data object types (e.g., files that may be executable or executed with an interpreter such as batch files (.bat), binary files (.bin), executable files (.exe), etc.); image data object types (e.g., image file types used when creating and/or saving images on a computing device such as bitmap images (.bmp), JPEG images (.jpeg), PNG images (.png), etc.); programming data object types (e.g., files used for programs before and after compiling such as C and C++ source code files (.c), Java class files (.java), Java Source code files (.java), etc.); system-related data object types (e.g., files used by operating systems or other programs such as core dump files (.dmp), temporary files (.tmp), configuration files (.cfg), backup files (.bak), etc.); video data object types (e.g., video file formats, standards, and extensions such as Audio Video Interleave (AVI) files (.avi), MPEG4 video files (.mpeg), etc.); word processing data object types (e.g., text or other word processing files used to create documents on a computing device such as PDF files (.pdf), plain text files (.txt), etc.); etc.

In some implementations, diagnostic data object types may include, but are not limited to data object types that may be used to diagnose performance of and/or errors associated with a program, an application, a software module, a hardware module, etc. Diagnostic data object types may generally include but are not limited to database data object types (e.g., data files related to a database such as comma separated value files (.csv), data files (.dat or .data), log files (.log), XML files (.xml), etc.); executable data object types (e.g., files that may be executable or executed with an interpreter such as batch files (.bat), binary files (.bin), executable files (.exe), etc.); programming data object types (e.g., files used for programs before and after compiling such as C and C++ source code files (.c), Java class files (.java), Java Source code files (.java), etc.); system-related data object types (e.g., files used by operating systems or other programs such as core dump files (.dmp), temporary files (.tmp), configuration files (.cfg), backup files (.bak), etc.); etc. In some implementations, the plurality of data object types may be specified and/or identified by a data object name and/or a data object extension. For example, a data object with the data object name or filename “app1.log” may be a log data object type for a specific application (e.g., app1 and/or client applications 22, 24, 26, 28), Additional data object names and/or data object extensions associated with a data object type may include, but are not limited to, “*_server.log” and/or “*_client.log”.

In some implementations, storage management process 10 may receive 402 a ranking in the form of a list (e.g., data object type ranking list 302). For example, storage management process 10 may receive a selection of the plurality of data object types and a ranking or priority associated with one or more of the selected plurality of data object types. In some implementations, storage management process 10 may receive 402 the ranking of the plurality of data object types via a user interface (not shown). In some implementations, the ranking of the plurality of data object types may indicate which data object types of the plurality of data object types are more important to a user and which data object types are less important to a user. In some implementations, one or more data object types not included in the ranking may be assigned a default ranking or may be designated as ineligible or protected for removal by storage management process 10. For example, one or more data object types associated with one or more data objects may be designated by storage management process 10 for storage in the storage array as ineligible (e.g., designated as “other data object types” for example purposes only) for and/or protected from removal by storage management process 10. Additionally and/or alternatively, one or more data object types that may not be included in the ranking of the plurality of data object types may be designated by storage management process 10 as ineligible for and/or protected from removal.

In some implementations, the ranking of the plurality of data object types may include a ranking of diagnostic data object types. In some implementations, a user (e.g., via storage management process 10) may want to prioritize the storage of diagnostic data objects or files associated with certain applications. Accordingly, storage management process 10 may receive 402 a ranking (e.g., data object type ranking list 302) of the plurality of data object types with a ranking of a plurality of diagnostic data object types for specific applications. Additionally and/or alternatively, a user (e.g., via storage management process 10) may want to prioritize log data objects (e.g., .log files) over configuration data objects (e.g., .config and/or .cfg files). Accordingly, storage management process 10 may receive a ranking (e.g., data object type ranking list 302) of the plurality of data objects with a ranking of log data objects and configuration data objects. As will be discussed in greater detail below, storage management process 10 may remove the configuration data objects before removing the log data objects, even if the log data objects are, for example, older data objects. It will be appreciated that other specific data object types may be ranked in various implementations of the present disclosure.

In some implementations, storage management process 10 may remove 404 one or more data objects of a plurality of data objects from the storage array based upon, at least in part, the ranking of the one or more data object types of a plurality of data object types associated with the one or more data objects of the plurality of data objects. In some implementations, storage management process 10 may remove the one or more data objects in response to determining that that the current storage usage plus the storage capacity required to store the at least one data object exceeds the maximum storage usage of the storage array. Referring again to the example implementation of FIG. 3, assume, for example purposes only, that storage management process 10 receives a ranking of three data object types (e.g., data object types 304, 306, 308) associated with one or more data objects (e.g., data objects 310, 312, 314, 316, 318, 320, 322, 324, 326). As discussed above, in some implementations, other data object types (e.g., one or more data object types 328 not included in data object type ranking list 302 and/or designated as ineligible from removal) may include one or more data objects (e.g., data objects 330, 332, 334). Assume, again for example purposes only, that the three data object types are ranked from most important to least important as data object type 304, data object type 306, and data object type 308.

In some implementations where storage management process 10 determines that the maximum storage usage for data array 212 has been exceeded, storage management process 10 may remove 404 one or more data objects (e.g., data objects 310, 312, 314, 316, 318, 320, 322, 324, 326) of the plurality of data objects (e.g., data object types 304, 306, 308) based upon, at least in part, the ranking of the plurality of data object types. Storage management process 10 may remove one or more of data objects 322, 324, 326 of data object type 308 first because data object type 308 may have the lowest ranking of the three data object types in the ranked list (e.g., data object type ranking list 302) of data object types. In some implementations, storage management process 10 may determine if the maximum storage usage is exceeded after the removal of one or more of data objects 322, 324, 326. If the maximum storage usage is still exceeded, storage management process 10 may remove one or more additional data objects until the maximum storage usage is no longer exceeded based upon, at least in part, the ranking of the plurality of data object types (e.g., data object type ranking list 302) and may store the at least one data object (data object 300) in the storage array (e.g., data array 212). If the maximum storage usage is no longer reached or exceeded after removal of one or more of data objects 322, 324, 326 storage management process 10 may store data object 300 in the storage array (e.g., data array 212).

In some implementations, removing 404 the one or more data objects may include removing 410 one or more core dump data objects of one or more data object types generated within a predefined period of time. A core dump data object may generally include a recorded state of the working memory of a computer program or application (e.g., client applications 22, 24, 26, 28) at a specific time, generally when the program or application has crashed or otherwise terminated abnormally. In some implementations, a core dump data object may include other pieces of program state such as the processor registers (which may include the program counter and stack pointer), memory management information, and other processor and operating system flags and information. In some implementations, the one or more core dump data objects may be used (e.g., via storage management process 10 and/or other client applications 22, 24, 26, 28) to diagnose why a program has crashed and/or to help understand how a program is running.

In some implementations, one or more core dump files may be generated within a predefined period of time. For example, suppose that a first application (e.g., client application 22, 24, 26, 28) crashes or dumps core dump files continuously. In some implementations, these core dump files generated by the first application may be redundant as the first application may crash or dump a first set of core dump files continuously. In contrast, suppose for example purposes only that a second application (e.g., client application 22, 24, 26, 28) crashes or dumps a second set of core dump data objects once. In some implementations, storage management process 10 may remove the redundant or frequent core dump data objects generated by the first application within or during a predefined period of time. The predefined period of time may be user-defined, may be defined by storage management process 10, and/or may be defined by an application (e.g., client application 22, 24, 26, 28). It will be appreciated that other sources may define the predefined period of time.

In some implementations, storage management process 10 may remove 410 the one or more core dump data objects of one or more data object types generated within a predefined period of time based upon, at least in part, the ranking of the one or more data object types of a plurality of data object types associated with the one or more core dump data objects. Assume, for example purposes only, that data objects 312, 314 of data file type 304, data object 320 of data file type 306, and data object 326 of data file type 308 are core dump data objects generated within the predefined period of time. Also assume, for example purposes only, that the ranking of the three data object types is from most important to least important as data object type 304, data object type 306, and data object type 308. In this example, storage management process 10 may remove 410 core dump data object 326 of data object type 308 based upon, at least in part, the ranking of the plurality of data object types in data object type ranking list 302. In this example, storage management process 10 may determine if the maximum storage usage is exceeded after the removal of core dump data object 326. If the maximum storage usage is still exceeded, storage management process 10 may remove one or more additional core dump data objects until the maximum storage usage is no longer exceeded based upon, at least in part, the ranking of the plurality of data object types (e.g., data object type ranking list 302) and may store 406 the at least one data object (data object 300). If the maximum storage usage is no longer exceeded after removal of data object 326, storage management process 10 may store 406 data object 300 in the storage array (e.g., data array 212).

In some implementations, removing 404 the one or more data objects may include determining 412 a current storage usage for at least one data object type of the plurality of data object types in the storage array. In some implementations, storage management process 10 may determine 412 the current storage usage for the plurality of data object types by determining the current storage usage of the plurality of data objects associated with the plurality of data object types. In the example of FIG. 3, suppose, for example purposes only, storage management process 10 determines that the current storage usage of data object type 304 is, for example, 8% of the total storage capacity of data array 212 by determining 412 the current storage usage of data objects 310, 312, 314. Additionally, suppose storage management process 10 determines that the current storage usage of data object type 306 is, for example, 12% of the total storage capacity of data array 212 by determining 412 the current storage usage of data objects 316, 318, 320 and that the current storage usage of data object type 308 is, for example, 32% of the total storage capacity of data array 212 by determining 412 the current storage usage of data objects 322, 324, 326.

In some implementations, removing the one or more data objects may include determining 414 a maximum storage usage for the at least one data object type of the plurality of data objects types. In some implementations, the maximum storage usage, or storage space limitation, for the at least one data object type may generally represent the percent of the storage or disk usage allowed on specific disk for a given data object type and/or may be user-defined, defined by storage management process 10, and/or may be a default value per data object type. In some implementations, storage management process 10 may determine 414 the plurality of maximum storage usages for the plurality of data object types by receiving the plurality of maximum storage usages for the plurality of data object types. For example, storage management process 10 may receive a maximum storage usage/storage space limitation as a percentage of the total capacity of the storage array and/or as a maximum amount of storage capacity for the plurality of data object types. In the example of FIG. 3, storage management process 10 may, for example, receive a 10% maximum storage usage 336 for data object type 304, a 20% maximum storage usage 338 for data object type 306, a 30% maximum storage usage 340 for data object type 308, and a 30% maximum storage usage 342 for other data object types (e.g., other data object types 328). In some implementations, the remaining storage usage 344 (e.g., total storage capacity array less the maximum storage usage of the storage array), for example purposes only, may be 100%−90%=10%.

In some implementations, removing 404 the one or more data objects may include removing 416 the one or data objects until the current storage usage for the one or more data object types associated with the one or more data objects is below the maximum storage usage for the one or more data object types associated with the one or more data objects. Continuing with the above examples where storage management process 10 determines that the current storage usage of data object type 304 is, for example, 8%, the current storage usage of data object type 306 is 12%, and the current storage usage of data object type 308 is, for example, 32% and a maximum storage usage 336 for data object type 304 is, for example, 10%, a maximum storage usage 338 for data object type 306 is, for example, 20%, and a maximum storage usage 340 for data object type 308 is, for example, 30%, storage management process 10 may remove 416 one or more data objects until the current storage usage for the one or more data object types is below the maximum storage usage. For example, storage management process 10 may determine 412 that the current storage usage for data object type 308 (e.g., 32%) exceeds the maximum storage usage for that data object type (e.g., for example, 30%). Accordingly, storage management process 10 may remove 416 one or more data objects (e.g., data objects 322, 324, 326) associated with data object type 308 until the current storage usage for data object type 308 no longer exceeds the maximum storage usage (e.g., for example, 30%). Additionally and/or alternatively, storage management process 10 may remove the one or more data objects until the current storage usage for the storage array plus the storage space required to store data object 300 is below the maximum storage usage for the storage array.

In some implementations, removing 404 the one or more data objects may include removing 418 one or more oldest data objects of the one or more data objects of the one or more data object types. For example, if storage management process 10 determines that the maximum storage usage of one or more data object types is reached or exceeded, storage management process 10 may remove 418 one or more of the oldest files until the current storage usage of the one or more data object types is below the maximum storage usage. Suppose, for example purposes only, that data object 322 of data object type 308 is the oldest (e.g., has been in data array 212 for the longest period of time) of data objects 322, 324, 326 followed by data object 324 and data object 326. In this example, storage management process 10 may remove 418 the oldest data object (e.g., data object 322). Additionally, storage management process 10 may remove the next oldest data object (e.g., data object 324 and/or data object 326) until storage management process 10 determines that the current storage usage for data object type 308 no longer exceeds the maximum storage usage (e.g., 30%). Additionally and/or alternatively, storage management process 10 may remove the one or more oldest data objects until the current storage usage for the storage array plus the storage space required to store data object 302 is below the maximum storage usage for the storage array.

In some implementations, removing 404 the one or more data objects may include removing 420 one or more data objects of a first data object type based upon, at least in part, the ranking of the first data object type and when each of the one or more data objects of the first data object type are removed, removing 422 one or more data objects of a second data object type based upon, at least in part, the ranking of the second data object type. For example, storage management process 10 may remove 420 one or more data objects (e.g., data objects 322, 324, 326) of a first data object type (e.g., data object type 308) based upon, at least in part, the ranking of first data object type (e.g., data object type 308). In this example, the first data object type (e.g., data object type 308) may have the lowest ranking and/or may be the most insignificant data object type based upon the data object type ranking list (e.g., data object type ranking list 302). As such, storage management process 10 may remove one or more data objects (e.g., data objects 322, 324, 326).

In some implementations, when each of the one or more data objects of the first data object type (e.g., data object type 308) are removed and, for example purposes only, storage management process determines that the current storage usage for the storage array plus the storage space required to store data object 300 reaches or exceeds the maximum storage usage for the storage array, storage management process 10 may remove 422 one or more data objects (e.g., data objects 316, 318, 320) of a second data object type (e.g., data object type 306) based upon, at least in part, the ranking of the second data object type (e.g., data object type 306). In this example, the second data object type (e.g., data object type 306) may have the next lowest ranking after the first data object type based upon the data object type ranking list (e.g., data object type ranking list 302). As such, storage management process 10 may remove 422 one or more data objects (e.g., data objects 316, 318, 320) of the second data object type (e.g., data object type 306).

In some implementations, storage management process 10 may continue to remove 404 one or more data objects of one or more data object types based upon, at least in part, the ranking of the plurality of data object types. For example, storage management process 10 may remove 404 the one or more data objects of each data object type until the current storage usage for the storage array plus the storage space required to store data object 300 is lower than the maximum storage usage for the storage array.

In some implementations, removing the one or more data objects may include removing 424 a data object of the one or more data objects of a first data object type based upon, at least in part, the ranking of the first data object type and removing 426 a data object of a second data object type based upon, at least in part, the ranking of the second data object type. For example, storage management process 10 may remove 424 a data object (e.g., data object 326) of a first data object type (e.g., data object type 308) based upon, at least in part, the ranking of first data object type (e.g., data object type 308). In this example, the first data object type (e.g., data object type 308) may have the lowest ranking and/or may be the most insignificant data object type based upon the data object type ranking list (e.g., data object type ranking list 302). As such, storage management process 10 may remove 424 a data object of the one or more data objects (e.g., data objects 322, 324, 326) of the first data object type (e.g., data object type 308). In some implementations, storage management process 10 may remove 418 the oldest data object of the one or more data objects. In this example, storage management process 10 may remove the oldest data object (e.g., data object 322) of the one or data objects (e.g., data objects 322, 324, 326) of the first data object type (e.g., data object type 308).

In some implementations, after removing a data object of the first data object type, storage management process 10 may remove 426 a data object of the second data object type (e.g., data object type 306) based upon, at least in part, the ranking of the second data object type (e.g., data object type 306). In this example, the second data object type (e.g., data object type 306) may have the next lowest ranking after the first data object type based upon the data object type ranking list (e.g., data object type ranking list 302). As such, storage management process 10 may remove 426 a data object of the one or more data objects (e.g., data objects 316, 318, 320) of the second data object type (e.g., data object type 306). In some implementations, storage management process 10 may remove 418 the oldest data object of the one or more data objects. In this example, storage management process 10 may remove the oldest data object (e.g., data object 316) of the one or data objects (e.g., data objects 316, 318, 320) of the second data object type (e.g., data object type 306).

In some implementations, storage management process 10 may continue to remove 404 a data object of the one or more data objects of the one or more data object types based upon, at least in part, the ranking of the plurality of data object types. For example, storage management process 10 may remove a data object from each data object type until the current storage usage for the storage array plus the storage space required to store data object 300 is lower than the maximum storage usage for the storage array. In some implementations, storage management process 10 may repeat this process one or more times until the current storage usage for the storage array plus the storage space required to store data object 300 is lower than the maximum storage usage for the storage array.

Storage management process 10 may store 406 the at least one data object in the storage array. In some implementations, when storage management process 10 has determined that the current storage usage for the storage array plus the storage space required to store data object 300 is lower than the maximum storage usage for the storage array, storage management process 10 may store the at least one data object (e.g., data object 300) in the storage array (e.g., data array 212).

In some implementations, it may be observed that the remaining one or more data objects may be the most important data objects. In some implementations, storage management process 10 may help use the storage space and/or disk space of a storage array (e.g., data array 212) more efficiently. Further, applying storage management process 10 to data collection (DC) may help identify root causes of core dumps and may reduce triage and support costs.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
receiving, at the computing device, a plurality of requests to store at least one data object in a storage array;
receiving a ranking of a plurality of data object types in order of significance;
removing one or more data objects of a plurality of data objects from the storage array based upon, at least in part, the ranking of the one or more data object types of a plurality of data object types associated with the one or more data objects of the plurality of data objects; and
storing the at least one data object in the storage array.

2. The computer-implemented method of claim 1, wherein receiving the plurality of requests to store the at least one data object includes determining a maximum storage usage for the storage array.

3. The computer-implemented method of claim 1, wherein removing the one or more data objects includes removing one or more core dump data objects of one or more data object types generated within a predefined period of time.

4. The computer-implemented method of claim 1, wherein removing the one or more data objects includes:
determining a current storage usage for at least one data object type of the plurality of data object types in the storage array,
determining a maximum storage usage for the at least one data object type of the plurality of data objects types, and
removing the one or data objects until the current storage usage for the one or more data object types associated with the one or more data objects is below the maximum storage usage for the one or more data object types associated with the one or more data objects.

5. The computer-implemented method of claim 1, wherein removing the one or more data objects includes:
removing one or more data objects of a first data object type based upon, at least in part, the ranking of the first data object type, and
when each of the one or more data objects of the first data object type are removed, removing one or more data objects of a second data object type based upon, at least in part, the ranking of the second data object type.

6. The computer-implemented method of claim 1, wherein removing the one or more data objects includes:
removing a data object of a first data object type based upon, at least in part, the ranking of the first data object type, and
removing a data object of a second data object type based upon, at least in part, the ranking of the second data object type.

7. The computer-implemented method of claim 1, wherein removing the one or more data objects includes removing one or more oldest data objects of the one or more data objects of the one or more data object types.

8. A computer program product residing on a non-transitory computer readable medium having a plurality of instructions stored thereon which, when executed by a processor, cause the processor to perform operations comprising:
receiving a plurality of requests to store at least one data object in a storage array;
receiving a ranking of a plurality of data object types in order of significance;
removing one or more data objects of a plurality of data objects from the storage array based upon, at least in part, the ranking of the one or more data object types of a plurality of data object types associated with the one or more data objects of the plurality of data objects; and
storing the at least one data object in the storage array.

9. The computer program product of claim 8, wherein receiving the plurality of requests to store the at least one data object includes determining a maximum storage usage for the storage array.

10. The computer program product of claim 8, wherein removing the one or more data objects includes removing one or more core dump data objects of one or more data object types generated within a predefined period of time.

11. The computer program product of claim 8, wherein removing the one or more data objects includes:
determining a current storage usage for at least one data object type of the plurality of data object types in the storage array,
determining a maximum storage usage for the at least one data object type of the plurality of data objects types, and
removing the one or data objects until the current storage usage for the one or more data object types associated with the one or more data objects is below the maximum storage usage for the one or more data object types associated with the one or more data objects.

12. The computer program product of claim 8, wherein removing the one or more data objects includes:
removing one or more data objects of a first data object type based upon, at least in part, the ranking of the first data object type, and
when each of the one or more data objects of the first data object type are removed, removing one or more data objects of a second data object type based upon, at least in part, the ranking of the second data object type.

13. The computer program product of claim 8, wherein removing the one or more data objects includes:
removing a data object of a first data object type based upon, at least in part, the ranking of the first data object type, and
removing a data object of a second data object type based upon, at least in part, the ranking of the second data object type.

14. The computer program product of claim 8, wherein removing the one or more data objects includes removing one or more oldest data objects of the one or more data objects of the one or more data object types.

15. A computing system including a processor and memory configured to perform operations comprising:
receiving a plurality of requests to store at least one data object in a storage array;
receiving a ranking of a plurality of data object types in order of significance;
removing one or more data objects of a plurality of data objects from the storage array based upon, at least in part, the ranking of the one or more data object types of a plurality of data object types associated with the one or more data objects of the plurality of data objects; and
storing the at least one data object in the storage array.

16. The computing system of claim 15, wherein receiving the plurality of requests to store the at least one data object includes determining a maximum storage usage for the storage array.

17. The computing system of claim 15, wherein removing the one or more data objects includes removing one or more core dump data objects of one or more data object types generated within a predefined period of time.

18. The computing system of claim 15, wherein removing the one or more data objects includes:
determining a current storage usage for at least one data object type of the plurality of data object types in the storage array,
determining a maximum storage usage for the at least one data object type of the plurality of data objects types, and
removing the one or data objects until the current storage usage for the one or more data object types associated with the one or more data objects is below the maximum storage usage for the one or more data object types associated with the one or more data objects.

19. The computing system of claim 15, wherein removing the one or more data objects includes:
removing one or more data objects of a first data object type based upon, at least in part, the ranking of the first data object type, and
when each of the one or more data objects of the first data object type are removed, removing one or more data objects of a second data object type based upon, at least in part, the ranking of the second data object type.

20. The computing system of claim 15, wherein removing the one or more data objects includes:
removing a data object of a first data object type based upon, at least in part, the ranking of the first data object type, and
removing a data object of a second data object type based upon, at least in part, the ranking of the second data object type.
